(19) United States
(12) Patent Application Publication
(10) Pub. No.: US 2024/0297395 A1
(43) Pub. Date: Sep. 5, 2024

(54) SEPARATOR FOR BATTERY PACK OF ELECTRIFIED VEHICLE

(71) Applicant: Ford Global Technologies, LLC, Dearborn, MI (US)

(72) Inventors: Xiaogang Zhang, Novi, MI (US); Jianwen James Yi, West Bloomfiled, MI (US); Mohammadreza Eftekhari, Novi, MI (US); Steven Wooldridge, Manchester, MI (US)

(21) Appl. No.: 18/115,850

(22) Filed: Mar. 1, 2023

(51) Int. Cl. H01M 50/293; H01M 10/6554; H01M 10/658; H01M 50/209

(52) U.S. Cl. CPC H01M 50/293; H01M 10/6554; H01M 10/658; H01M 50/209

(57) ABSTRACT

This disclosure relates generally to battery packs for electrified vehicles, and in particular relates to a separator for a battery pack. The battery pack may include a battery array including a first battery cell spaced-apart from a second battery cell by a separator, wherein the separator includes a first layer of material in contact with the first battery cell and a second layer of material in contact with the second battery cell, wherein the first and second layers of material are made of a thermally insulative material, wherein the separator includes a third layer of material and a fourth layer of material between the first and second layers of material, and wherein the third and fourth layers of material are made of a metallic material.

### TECHNICAL FIELD

This disclosure relates generally to battery packs for electrified vehicles, and in particular relates to a separator for a battery pack.

### BACKGROUND

The need to reduce automotive fuel consumption and emissions is well known. Therefore, vehicles are being developed that reduce or completely eliminate reliance on internal combustion engines. Electrified vehicles are one type of vehicle being developed for this purpose. In general, electrified vehicles differ from conventional motor vehicles because they are selectively driven by battery powered electric machines. Conventional motor vehicles, by contrast, rely exclusively on an internal combustion engine to propel the vehicle.

A high voltage battery pack typically powers the electric machines and other electrical loads of the electrified vehicle. The battery pack includes a plurality of battery cells and various other battery internal components that support electric propulsion of electrified vehicles.

The battery cells generate heat during charging and discharging operations. This heat must be dissipated in order to achieve a desired level of battery performance. Heat exchanger plates, sometimes referred to as thermal exchange plates or “cold plates,” are often employed to dissipate the heat generated by the battery cells. Battery packs are known to include other structures, such as separators, configured to dissipate heat.

### SUMMARY

In some aspects, the techniques described herein relate to a battery pack, including: a battery array including a first battery cell spaced-apart from a second battery cell by a separator, wherein the separator includes a first layer of material in contact with the first battery cell and a second layer of material in contact with the second battery cell, wherein the first and second layers of material are made of a thermally insulative material, wherein the separator includes a third layer of material and a fourth layer of material between the first and second layers of material, and wherein the third and fourth layers of material are made of a metallic material.

In some aspects, the techniques described herein relate to a battery pack, wherein the first and second layers of material are made of a non-metallic material.

In some aspects, the techniques described herein relate to a battery pack, wherein the first and second layers of material are made of aerogel.

In some aspects, the techniques described herein relate to a battery pack, wherein the third and fourth layers of material are made of steel.

In some aspects, the techniques described herein relate to a battery pack, further including: a fifth layer of material between the third and fourth layers of material, wherein the fifth layer of material is made of a thermally insulative material.

In some aspects, the techniques described herein relate to a battery pack, wherein the fifth layer is a middle-most layer of the separator with respect to a thickness dimension of the separator.

In some aspects, the techniques described herein relate to a battery pack, wherein the thermally insulative material is aerogel and the metallic material is steel.

In some aspects, the techniques described herein relate to a battery pack, wherein: the first, second, and fifth layers of material exhibit a common thickness, and the third and fourth layers of material exhibit a common thickness different than the thickness of the first, second, and fifth layers.

In some aspects, the techniques described herein relate to a battery pack, wherein: the first, second, and fifth layers of material exhibit a thickness of substantially 1 mm, and the third and fourth layers of material exhibit a thickness of substantially 0.75 mm.

In some aspects, the techniques described herein relate to a battery pack, wherein a total thickness of the separator is substantially 4.5 mm.

In some aspects, the techniques described herein relate to a battery pack, further including: a thermal exchange plate adjacent the battery array, wherein the thermal exchange plate is in contact with the third and fourth layers directly or by way of a thermally insulating material.

In some aspects, the techniques described herein relate to a battery pack, wherein: the thermal exchange plate is a first thermal exchange plate adjacent a side of the third and fourth layers, the battery pack further includes a second thermal exchange plate adjacent an opposite side of the third and fourth layers as the first thermal exchange plate, and the second thermal exchange plate is in contact with the third and fourth layers directly or by way of a thermally insulating material.

In some aspects, the techniques described herein relate to a battery pack, wherein the separator consists of two layers of metallic material.

In some aspects, the techniques described herein relate to a battery pack, wherein the battery pack is configured such that a compressive force applied along a length of the array holds the separator in place relative to the first battery cell and the second battery cell.

In some aspects, the techniques described herein relate to a battery pack, wherein the battery pack is a battery pack of an electrified vehicle.

In some aspects, the techniques described herein relate to a separator for a battery pack, including: a first layer of material configured to contact a first battery cell, a second layer of material configured to contact a second battery cell adjacent the first battery cell, wherein the first and second layers of material are made of a thermally insulative material; and a third layer of material and a fourth layer of material between the first and second layers of material, wherein the third and fourth layers of material are made of a metallic material.

In some aspects, the techniques described herein relate to a separator, wherein: the first and second layers of material are made of aerogel, the third and fourth layers of material are made of steel, the separator further includes a fifth layer of material between the third and fourth layers of material, and the fifth layer of material is made of aerogel.

In some aspects, the techniques described herein relate to a separator, wherein: the first, second, and fifth layers of material exhibit a thickness of substantially 1 mm, the third and fourth layers of material exhibit a thickness of substantially 0.75 mm, and a total thickness of the separator is substantially 4.5 mm.

In some aspects, the techniques described herein relate to a method, including: thermally insulating a first battery cell of a battery pack from a second battery cell of the battery pack by providing a separator between the first battery cell and the second battery cell, wherein the separator includes a first layer of material in contact with the first battery cell and a second layer of material in contact with the second battery cell, wherein the first and second layers of material are made of a thermally insulative material, wherein the separator includes a third layer of material and a fourth layer of material between the first and second layers of material, and wherein the third and fourth layers of material are made of a metallic material.

In some aspects, the techniques described herein relate to a method, wherein: the first and second layers of material are made of aerogel, the third and fourth layers of material are made of steel, the separator further includes a fifth layer of material between the third and fourth layers of material, and the fifth layer of material is made of aerogel.

### BRIEF DESCRIPTION OF THE DRAWINGS

FIG. 1 schematically illustrates an example powertrain of an electrified vehicle.

FIG. 2 is a perspective, exploded-view of a portion of an example battery pack.

FIG. 3 is a side view of a portion of the battery pack.

FIG. 4 is a top perspective view of a portion of a separator.

FIG. 5 is a side view of a portion of the battery pack and illustrates an exemplary arrangement of the separator relative to two thermal exchange plates.

### DETAILED DESCRIPTION

This disclosure relates generally to battery packs for electrified vehicles, and in particular relates to a separator for a battery pack. Among other benefits, which will be appreciated from the below description, this disclosure reduces heat transferred between adjacent battery cells, without requiring additional material or space relative to known designs.

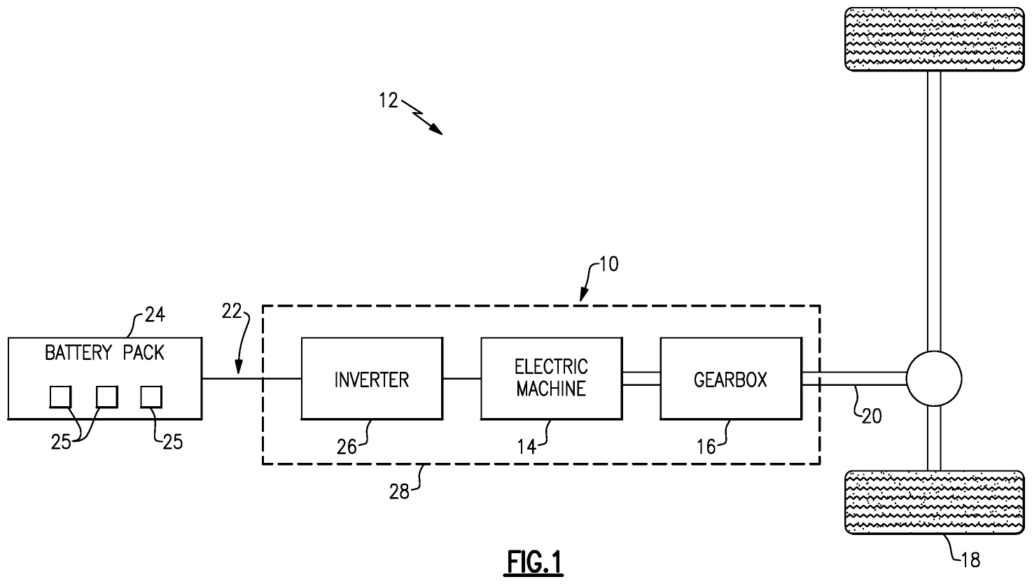

FIG. 1 schematically illustrates a powertrain 10 of an electrified vehicle 12. Although depicted as a battery electric vehicle (BEV), it should be understood that the concepts described herein are not limited to BEVs and could extend to other electrified vehicles, including but not limited to, plug-in hybrid electric vehicles (PHEVs). Therefore, although not shown in this embodiment, the electrified vehicle 12 could be equipped with an internal combustion engine that can be employed in combination with other energy sources to propel the electrified vehicle 12.

In a non-limiting embodiment, the electrified vehicle 12 is a full electric vehicle propelled solely through electric power, such as by an electric machine 14, without any assistance from an internal combustion engine. The electric machine 14 may operate as an electric motor, an electric generator, or both. The electric machine 14 receives electrical power and provides a rotational output power. The electric machine 14 may be connected to a gearbox 16 for adjusting the output torque and speed of the electric machine 14 by a predetermined gear ratio. The gearbox 16 is connected to a set of drive wheels 18 by an output shaft 20. A high voltage bus 22 electrically connects the electric machine 14 to a battery pack 24 through an inverter 26. The electric machine 14, the gearbox 16, and the inverter 26 may collectively be referred to as a transmission 28.

The battery pack 24 is an exemplary electrified vehicle battery. The battery pack 24 may be a high voltage traction battery pack that includes a plurality of battery assemblies 25 (i.e., battery arrays or groupings of battery cells) capable of outputting electrical power to operate the electric machine 14 and/or other electrical loads of the electrified vehicle 12. Other types of energy storage devices and/or output devices can also be used to electrically power the electrified vehicle 12.

The powertrain 10 shown in FIG. 1 is highly schematic and is not intended to limit this disclosure. Various additional components could alternatively or additionally be employed by the powertrain 10 within the scope of this disclosure.

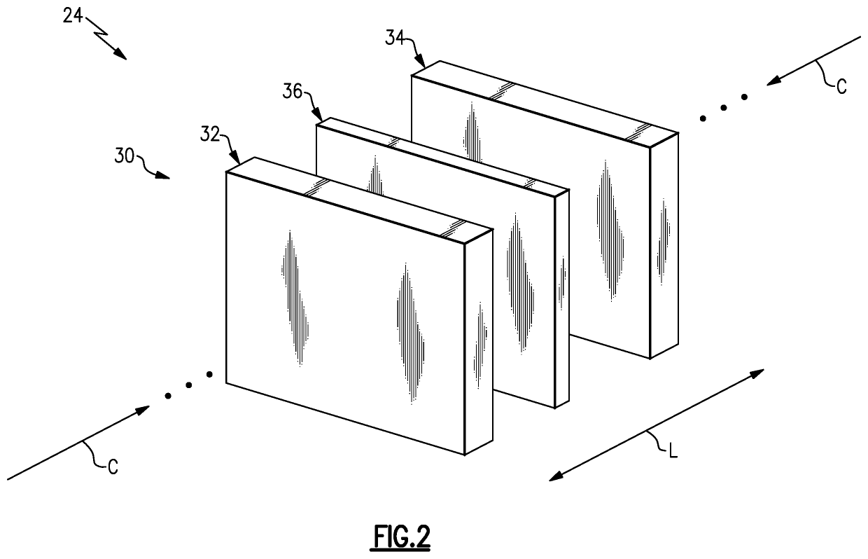

FIG. 2 illustrates some components of an example battery pack 24. Specifically, FIG. 2 illustrates a portion of a battery array 30, which includes a plurality of battery cells arranged along a length L of the battery array 30. The battery array 30 is enclosed by an enclosure assembly. The battery pack 24, through the enclosure assembly or otherwise, is configured to apply a compressive force C along the length of the battery array 30 to hold the components of the battery pack 24, namely the battery cells and other structures, such as separators, in place.

FIG. 2 illustrates two of the plurality of battery cells within the battery array 30. Specifically, FIG. 2 illustrates a first battery cell 32 and a second battery cell 34. The battery array 30 further includes a separator 36 between the first battery cell 32 and the second battery cell 34. The separator 36 may be referred to as a thermal separator and is configured to reduce heat transfer between the first battery cell 32 and the second battery cell 34.

In an embodiment, battery cells 32, 34 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

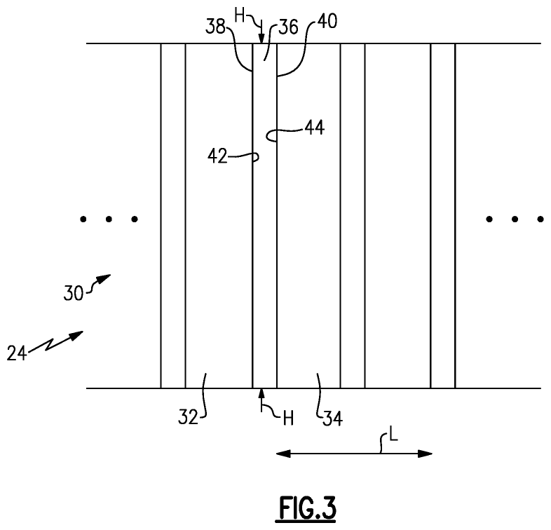

In FIG. 2, the first battery cell 32, second battery cell 34, and separator 36 are shown spaced-apart from one another along the length L of the battery array 30. When the battery array 30 is assembled, however, the battery pack 24 is configured to apply a compressive force C to the first battery cell 32, second battery cell 34, and separator 36 such that the first battery cell 32 is in direct contact with the separator 36, and such that the second battery cell 34 is in direct contact with the separator 36, as represented in FIG. 3.

FIG. 3 illustrates a side view of a portion of the battery array 30. As shown, the first battery cell 32, second battery cell 34, and separator 36 are stacked face-to-face along a length L of the battery array 30. In particular, the separator 36 includes a first face 38 and a second face 40 opposite the first face 38. The first face 38 is in direct contact with an adjacent face 42 of the first battery cell 32, and the second face 40 is in direct contact with an adjacent face 44 of the second battery cell 34.

Along the length L of the battery array 30, there is a separator between each battery cell in this example. In other examples, there may be a separator between adjacent groups of battery cells, such as between every two or every four battery cells.

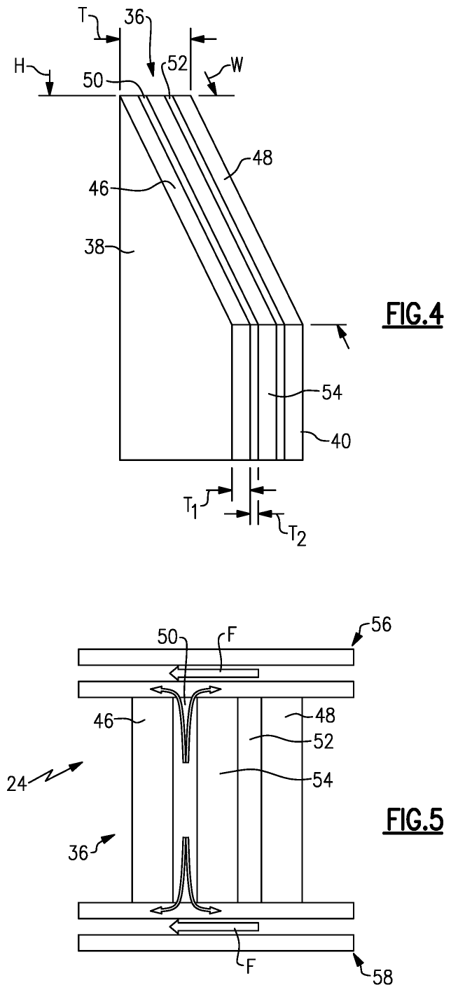

FIG. 4 illustrates additional detail of the separator 36. In this disclosure, the separator 36 includes a plurality of layers of material. In general, the separator 36 exhibits a height H (best seen in FIG. 3) and a width W. The separator 36 exhibits an overall thickness T, which is substantially 4.5 mm. The term “substantially” as used herein to refer to particular dimensions is intended to encompass a designed dimension and reasonable tolerances. For instance, the thickness T is designed to be 4.5 mm but in practice may vary slightly, within reasonable tolerances.

In this disclosure, the separator 36 includes a first layer of thermally insulative material 46 (each layer may be referred to, for example, using shorthand, such that the first layer of thermally insulative material 46 may be referred to as “first layer 46” or “layer 46”) providing the first face 38. The first layer 46 is configured to directly contact the first battery cell 32. The separator 36 includes a second layer of thermally insulative material 48 on an opposite side of the separator 36. The second layer 48 provides the second face 40 such that the second layer 48 is configured to directly contact the second battery cell 34.

Moving inwardly from first and second layers 46, 48, The separator 36 also includes a third layer of material 50 and a fourth layer of material 52 between the first and second layers 46, 48. The third and fourth layers 50, 52 are made of a metallic material, such as steel. The third and fourth layers 36, 38 directly contact a respective one of the layers 46, 48.

The third and fourth layers 50, 52 are spaced-apart from one another. Specifically, in this example, a fifth layer of material 54, which is made of thermally insulative material, is arranged between the third and fourth layers 50, 52. The fifth layer 54 is the middle-most layer of the separator 36, with respect to the direction of the thickness T.

The first, second, and fifth layers 46, 48, 54 are made of a non-metallic material. In particular, the first, second, and fifth layers 46, 48, 54 are made of an aerogel material. The first, second, and fifth layers 46, 48, 54 are thermally insulative and are configured to reduce heat transfer between the battery cells 32, 34. The third and fourth layers 50, 52 are configured to thermally conduct heat and structurally support the separator 36. Because the first and second layers 46, 48 are in direct contact with the battery cells 32, 34, however, heat transferred to the separator 36 is considerably reduced before reaching the third and fourth layers 50, 52. The third and fourth layers 50, 52 conduct heat to the fifth layer 54, where heat transfer is further reduced. Ultimately, in this disclosure, heat that would have otherwise been transferred between the first battery cell 32 and the second battery cell 34 unencumbered, is reduced by the three layers of thermally insulative material, namely layers 46, 48, 54.

Each of the layers 46, 48, 50, 52, 54 exhibits a common height and width in this example, which is substantially equal to the height H and width W of the separator 36. The height H and width of the separator 36 may be slightly greater than the corresponding height and width dimensions of the battery cells 32, 34.

In this example, the layers 46, 48, 54 exhibit a common thickness T₁, and the third and fourth layers 50, 52 a common thickness T₂ different than the thickness T₁. Here, thickness T₁ is substantially 1 mm, and thickness T₂ is substantially 0.75 mm. Again, the overall thickness T is substantially 4.5 mm. The arrangement of layers 46, 48, 50, 52, 54, and their respective thicknesses, provides the separator 36 with an overall thickness T substantially equal to the thickness of known separators, such that the design of the battery array 30 does not need to change to accommodate the separator 36. Further, relative to some known designs, such as designs that include only two layers of thermally insulative material, the separator 36 is configured such that heat must pass through a similar thickness of thermally insulative material. Despite having a similar overall thickness of thermally insulative material, the separator 36 reduces heat transfer by providing the thermally insulative material directly in contact with the adjacent battery cells, especially compared to designs with metallic layers directly contacting battery cells. Further still, the separator 36 consists of two layers of metallic material, namely layers 50, 52, which provides structural support, and provides a similar thickness of metallic material within the separator compared to some known designs with only one layer of metallic material. The central layer of thermally insulative material also facilitates a reduction in heat transfer relative to designs with only one layer of metallic material, such as a central layer of metallic material.

Because the layers 50, 52 are thermal conductors, in some embodiments the battery pack 24 may include one or more heat sinks in communication with the layers 50, 52. In FIG. 5, there are two thermal exchange plates 56, 58 arranged adjacent a top and a bottom of the separator 36, respectively. Fluid F is configured to flow through the thermal exchange plates 56, 58. The fluid F is configured to absorb heat from the layers 50, 52, which are directly in contact with the thermal exchange plates 56, 58 or indirectly in contact with the thermal exchange plates 56, 58 via a relatively thin layer of a thermal interface material (TIM). While two thermal exchange plates 56, 58 are shown, the battery pack 24 could include one or more thermal exchange plates, such as only one of the thermal exchange plates 56, 58.

It should be understood that terms such as “about,” “substantially,” and “generally” are not intended to be boundaryless terms, and should be interpreted consistent with the way one skilled in the art would interpret those terms. It should also be understood that directional terms such as “upper,” “top,” “vertical,” “forward,” “rear,” “side,” “above,” “below,” etc., are used herein relative to the normal operational attitude of a vehicle for purposes of explanation only, and should not be deemed limiting.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A battery pack, comprising:
a battery array including a first battery cell spaced-apart from a second battery cell by a separator, wherein the separator includes a first layer of material in contact with the first battery cell and a second layer of material in contact with the second battery cell, wherein the first and second layers of material are made of a thermally insulative material, wherein the separator includes a third layer of material and a fourth layer of material between the first and second layers of material, and wherein the third and fourth layers of material are made of a metallic material.

2. The battery pack as recited in claim 1, wherein the first and second layers of material are made of a non-metallic material.

3. The battery pack as recited in claim 2, wherein the first and second layers of material are made of aerogel.

4. The battery pack as recited in claim 1, wherein the third and fourth layers of material are made of steel.

5. The battery pack as recited in claim 1, further comprising:
a fifth layer of material between the third and fourth layers of material, wherein the fifth layer of material is made of a thermally insulative material.

6. The battery pack as recited in claim 5, wherein the fifth layer is a middle-most layer of the separator with respect to a thickness dimension of the separator.

7. The battery pack as recited in claim 5, wherein the thermally insulative material is aerogel and the metallic material is steel.

8. The battery pack as recited in claim 7, wherein:
the first, second, and fifth layers of material exhibit a common thickness, and
the third and fourth layers of material exhibit a common thickness different than the thickness of the first, second, and fifth layers.

9. The battery pack as recited in claim 8, wherein:
the first, second, and fifth layers of material exhibit a thickness of substantially 1 mm, and
the third and fourth layers of material exhibit a thickness of substantially 0.75 mm.

10. The battery pack as recited in claim 8, wherein a total thickness of the separator is substantially 4.5 mm.

11. The battery pack as recited in claim 1, further comprising:
a thermal exchange plate adjacent the battery array, wherein the thermal exchange plate is in contact with the third and fourth layers directly or by way of a thermally insulating material.

12. The battery pack as recited in claim 11, wherein:
the thermal exchange plate is a first thermal exchange plate adjacent a side of the third and fourth layers,
the battery pack further comprises a second thermal exchange plate adjacent an opposite side of the third and fourth layers as the first thermal exchange plate, and
the second thermal exchange plate is in contact with the third and fourth layers directly or by way of a thermally insulating material.

13. The battery pack as recited in claim 1, wherein the separator consists of two layers of metallic material.

14. The battery pack as recited in claim 1, wherein the battery pack is configured such that a compressive force applied along a length of the array holds the separator in place relative to the first battery cell and the second battery cell.

15. The battery pack as recited in claim 1, wherein the battery pack is a battery pack of an electrified vehicle.

16. A separator for a battery pack, comprising:
a first layer of material configured to contact a first battery cell,
a second layer of material configured to contact a second battery cell adjacent the first battery cell, wherein the first and second layers of material are made of a thermally insulative material; and
a third layer of material and a fourth layer of material between the first and second layers of material, wherein the third and fourth layers of material are made of a metallic material.

17. The separator as recited in claim 16, wherein:
the first and second layers of material are made of aerogel,
the third and fourth layers of material are made of steel,
the separator further comprises a fifth layer of material between the third and fourth layers of material, and
the fifth layer of material is made of aerogel.

18. The separator as recited in claim 17, wherein:
the first, second, and fifth layers of material exhibit a thickness of substantially 1 mm,
the third and fourth layers of material exhibit a thickness of substantially 0.75 mm, and
a total thickness of the separator is substantially 4.5 mm.

19. A method, comprising:
thermally insulating a first battery cell of a battery pack from a second battery cell of the battery pack by providing a separator between the first battery cell and the second battery cell, wherein the separator includes a first layer of material in contact with the first battery cell and a second layer of material in contact with the second battery cell, wherein the first and second layers of material are made of a thermally insulative material, wherein the separator includes a third layer of material and a fourth layer of material between the first and second layers of material, and wherein the third and fourth layers of material are made of a metallic material.

20. The method as recited in claim 19, wherein:
the first and second layers of material are made of aerogel,
the third and fourth layers of material are made of steel,
the separator further comprises a fifth layer of material between the third and fourth layers of material, and
the fifth layer of material is made of aerogel.
